(19) United States
(12) Patent Application Publication
(10) Pub. No.: US 2014/0379368 A1
(43) Pub. Date: Dec. 25, 2014

(54) METHOD AND APPARATUS FOR MANAGING PERSONAL HEALTH

(71) Applicant: Samsung Electronics Co., Ltd., Suwon-si, Gyeonggi-do (KR)

(72) Inventors: Do-Young Kim, Hwaseong-si (KR); Nae-Hyun Lim, Seoul (KR); Dong-Keon Kong, Suwon-si (KR); Yong Chang, Seongnam-si (KR); Hyoung-Kyu Lim, Seoul (KR)

(21) Appl. No.: 14/369,873

(22) PCT Filed: Dec. 26, 2012
(86) PCT No.: PCT/KR2012/011444

§ 371 Date: Jun. 30, 2014

(30) Foreign Application Priority Data
Dec. 28, 2011 (KR) 10-2011-0144090
Jan. 6, 2012 (KR) 10-2012-0001873

(51) Int. Cl. G06F 19/00

(52) U.S. Cl. CPC G06F 19/322
USPC 705/2

(57) ABSTRACT

A method and an apparatus for managing personal health are provided. A gateway capable of communicating with a health device and a non-health device sets up a communication link with a communication device according to a first communication protocol, and determines whether the health device. When the communication device is determined as a health device, the gateway executes a health security algorithm which provides a higher level of security than a security of a security algorithm applied to the first communication protocol, and communicates with the health device by using the health security algorithm.

### CROSS-REFERENCE TO RELATED APPLICATION(S)

This application is a U.S. National Stage application under 35 U.S.C. §371 of an International application filed on Dec. 26, 2012 and assigned application number PCT/KR2012/011444, which claimed the benefit of a Korean patent application filed on Dec. 28, 2011 in the Korean Intellectual Property Office and assigned Serial number 10-2011-0144090 and Korean patent application filed on Jan. 6, 2012 in the Korean Intellectual Property Office and assigned Serial number 10-2012-0001873, the entire disclosure of which is hereby incorporated by reference.

### TECHNICAL FIELD

The present disclosure relates to management of personal health. More particularly, the present disclosure relates to a method and an apparatus for safely managing Personal Health Record (PHR) by improving a security of the personal health record.

### BACKGROUND

A hospital-centered medical record management system has a problem in that personal health information is scattered in many medical organizations such that a hospital-centered medical record management system is not integrated but non-systematically operated, and a Personal Health Record (PHR) has been suggested to solve the problem. The PHR is directed to collectively managing medical treatment information of persons provided from medical organizations and health records recorded by the persons themselves. If the personal health records are used, persons can be provided with medical services and perform self-management anytime and anywhere, and can be provided with an on-demand medical service suitable for the persons (e.g., a healthcare service).

The healthcare service includes collecting and storing health data collected by various health devices such as a blood pressure monitor, a body temperature meter, a glucometer, and a blood analyzer. The health data is transmitted to an external medical service provider or provided to a user through a display unit such as a Television (TV), a mobile phone, or a smart phone. In order to support the health care service more efficiently, a health gateway for collecting and storing health data from health devices located in or around a house may be provided in the house. The health gateway performs communications with health devices using a near field communication technology such as WiFi, Bluetooth, or ZigBee.

For more efficient use of communication devices, the health gateway may be collocated with a general gateway/Access Point (AP) supporting communication with a general device such as a mobile phone, a smartphone, a notebook including a communication module, and a smart TV instead of a health device. In another case, an algorithm supporting a healthcare service may be additionally provided in the gateway supporting a wireless near field communication technology.

The health data requires a high security as compared with non-health data in that the health data includes not only simple individual information but private health information and life information such as a disease history of a user. However, because health devices use an existing general communication protocol according to the related art, a security of the same level as that of general devices is applied so that the requirements cannot be required.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a technology for providing a high security for health devices has been required in an environment in which health devices and non-health devices coexist using the same communication protocol.

Another aspect of the present disclosure is to provide a security method and a security apparatus for a health management system.

Another aspect of the present disclosure is to provide a method and an apparatus for providing a high security for health devices in an environment in which health devices and non-health devices coexist using the same communication protocol.

Another aspect of the present disclosure is to provide a method and an apparatus for reducing power consumption due to driving of an additional security algorithm for health devices.

Another aspect of the present disclosure is to provide an apparatus and a method for safely managing a Personal Health Record (PHR) by increasing a security of the personal health record.

Another aspect of the present disclosure is to provide an apparatus and a method for managing a PHR by which a resource can be efficiently used by determining whether a security of a health measuring unit is set according to situations.

In accordance with an aspect of the present disclosure, a method of providing a security by a gateway in a health system is provided. The method includes setting a communication link according to a first communication protocol with a communication device, determining whether the communication device is a health device, if the communication device is a health device, performing a health security algorithm providing a security of a level higher than a security of a security algorithm applied in the first communication protocol, and performing a communication with the health device by using the health security algorithm.

In accordance with another aspect of the present disclosure, a gateway apparatus for providing a security for a health system is provided. The gateway apparatus includes a transceiver configured to perform a communication with at least one communication device, and a controller configured to, if a communication link according to a first communication protocol with the communication device is set, determine whether the communication device is a health device, if the communication device is a health device, to perform a health security algorithm providing a security of a level higher than a security of a security algorithm applied in the first communication protocol, and to perform a communication with the health device by using the health security algorithm.

In accordance with another aspect of the present disclosure, a method of managing a health record is provided. The method includes receiving first control information on whether security of at least one measurement apparatus is executed from a health record management server or a user, transmitting second control information on whether security of the at least one measurement apparatus is executed to the at least one measurement apparatus based on the first control information, receiving data measured by the at least one measurement apparatus and generated based on the second control information, and providing the data to one or more of the health record management server and the user.

In accordance with another aspect of the present disclosure, a method of managing a health record is provided. The method includes determining whether a security of at least one measurement apparatus is executed and generating control information on whether a security of the at least one measurement apparatus is executed, transmitting the control information to the at least one measurement apparatus, and receiving data measured by the at least one measurement apparatus and generated based on the control information.

In accordance with another aspect of the present disclosure, a method of managing a health record is provided. The method includes determining whether a security is executed on health data based on control information provided by one or more of a health record management server and a user, measuring the health data, executing a security algorithm to set a security in the measured health data according to the determination, and transmitting the data in which the security is set to one or more of the health record management server and the user.

In accordance with another aspect of the present disclosure, an apparatus for managing a health record is provided. The apparatus includes a transmitter configured to transmit a signal, a receiver configured to receive a signal, and a controller configured to transmit second control information on whether security of the at least one measurement apparatus is executed to the at least one measurement apparatus based on the first control information on whether security of at least one measurement apparatus is executed from a health record management server or a user, and to receive data measured by the at least one measurement apparatus and generated based on the second control information and transmits the data to the health record management server or the user.

In accordance with another aspect of the present disclosure, an apparatus for managing a health record is provided. The apparatus includes a transmitter configured to transmit a signal, a receiver configured to receive a signal, a controller configured to determine whether a security is executed on at least one measurement apparatus, to generate control information on whether a security is executed, and to transmit the control information to the at least one measurement apparatus.

In accordance with another aspect of the present disclosure, an apparatus for managing a health record is provided. The apparatus includes a transmitter configured to transmit a signal, a receiver configured to receive a signal, a controller configured to determine whether a security is executed on health data based on control information provided by a health record management server or a user, and to execute a security algorithm to set a security in the measured health data according to whether a security is executed.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view exemplifying a configuration of a health system according to an embodiment of the present disclosure;

FIG. 2 is a message flowchart for explaining an execution procedure of a health security algorithm according to an embodiment of the present disclosure;

FIG. 3 is a message flowchart for explaining an ending procedure of a health security algorithm according to an embodiment of the present disclosure;

FIG. 4 is a flowchart showing an operation of executing a health security algorithm in a gateway according to an embodiment of the present disclosure;

FIG. 5 is a flowchart showing an operation of ending a health security algorithm in a gateway according to an embodiment of the present disclosure;

FIG. 6 is a block diagram showing a configuration of a gateway for executing a health security algorithm according to an embodiment of the present disclosure;

FIG. 7 is a view showing a Personal Health Record (PHR) management system according to an embodiment of the present disclosure;

FIG. 8 is a flowchart for explaining an operation of a PHR management system according to an embodiment of the present disclosure;

FIG. 9 is a flowchart for explaining an operation of a PHR management system according to an embodiment of the present disclosure;

FIG. 10 is a flowchart for explaining an operation of a PHR management system according to an embodiment of the present disclosure;

FIG. 11 is a flowchart for explaining an operation of a PHR management system according to an embodiment of the present disclosure;

FIG. 12 is a flowchart showing an operation of a health measurement control apparatus of a PHR management system according to an embodiment of the present disclosure;

FIG. 13 is a flowchart showing an operation of a PHR server of a PHR management system according to an embodiment of the present disclosure; and

FIG. 14 is a flowchart showing an operation of a measurement apparatus of a PHR management system according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

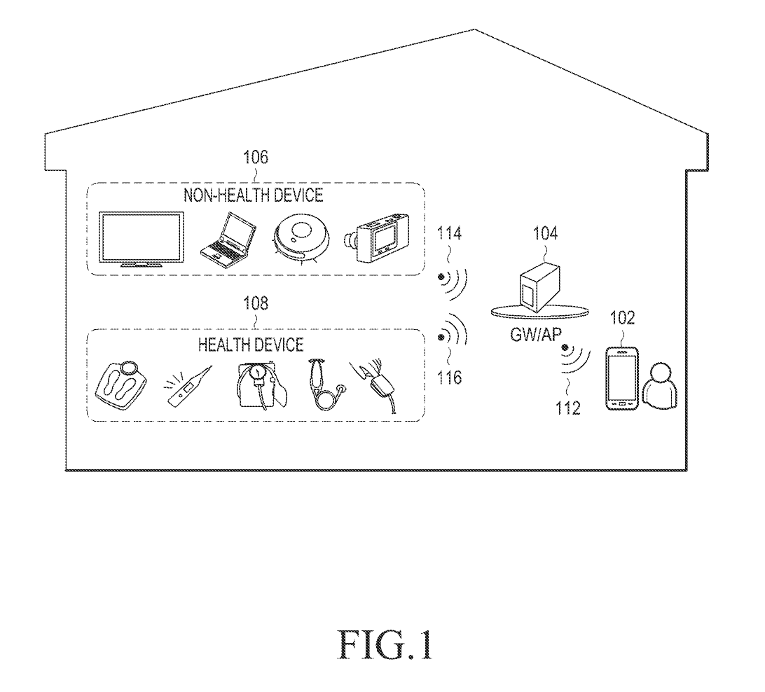

FIG. 1 exemplifies a configuration of a health system according to an embodiment of the present disclosure.

Referring to FIG. 1, a health system may include at least one health device 108 such as a scale, a glucometer, a blood pressure monitor, and/or the like, and a non-health device (also referred to as a general device) 106 such as a smart TV, a notebook including a communication module, an home appliance including a communication module, and/or the like. The health device 108 and the non-health device 106 may perform a communication by using the same communication protocol, for example, WiFi, Bluetooth, or ZigBee. In the specification, an embodiment of the present disclosure will be described while taking communication through WiFi as an example.

The health system may further include a portable terminal 102, a gateway/Access Point (AP), and/or the like. According to various embodiments of the present disclosure, the portable terminal 102, the gateway/AP 104, the non-health device 106, and/or the health device 108 may be electronic devices.

A gateway/AP (hereinafter, a gateway) 104 may perform communication with the non-health device 106 and/or the health device 108 through WiFi, and remote control data or health data as information according to communication with the non-health device 106 and the health device 108 are forwarded to a portable terminal 102 of a user and, if possible, a control command from the portable terminal 102 is forward to the non-health device 106 and the health deice 108. The gateway 104 may set a communication link 114 with the non-health device 106, a communication link 116 with the non-health device 108, and/or a communication link 112 and the portable terminal 102 by using a WiFi communication protocol, and may forward the data and the command through the communication links. According to various embodiments of the present disclosure, the gateway 104 may set communication links with the portable terminal 102 through the Internet, a mobile communication network to which the portable terminal 102 is subscribed, and/or the like.

The gateway 104, in particular, the gateway having an AP function may be opened to not only a registered user but a nonregistered user. In this case, a malicious nonregistered user may connect to the gateway 104 to steal private data by the health device 108. In particular, when the gateway 104 provides a security algorithm of the same level to all devices connected through WiFi, the problems may frequently occur. Thus, in the following various embodiments of the present disclosure, when the health device 108 is connected (e.g., to the gateway 104), an operation for applying a security algorithm of a higher level (e.g., a health security algorithm) to the communication link 116 with the health device 108 is provided. Because the details of the health security algorithm deviate from the scope of the present disclosure that is sought to be protected, the health security algorithm will be omitted. Then, when a general security algorithm of WiFi is applied to the communication link 114 with the non-health device 106, a health security algorithm is not applied.

The health security algorithm may be added to a general security algorithm of WiFi to be performed. The general security algorithm specifically includes a security using an approach control based Service Set Identifier (SSID), a security using a privacy based Wired Equivalent Privacy (WEP), and/or the like.

When the health devices and the non-health devices use the same type of communication protocol (e.g., WiFi), the gateway 104 requires an additional operation to classify devices connected to the gateway 104, (e.g., to determine whether the connected devices are health devices).

According to various embodiments of the present disclosure, the gateway 104 stores information on a health device usable by the user in a Data Base (DB) and manages the information. For example, before using a health device in a house for the first time, the user registers identification information on the health device, for example, a serial number of the device, a Media Access Control (MAC) address, and a WiFi version in the gateway 104. The DB may further include profile information such as the type of the health device, a manufacturer of the device, and/or the like together with the identification information on the health device.

According to various embodiments of the present disclosure, when transmitting a message requesting setting of a communication link to the gateway 104, the health device 108 transmits the profile information on the type of the device in the message. The profile information may simply indicate whether the device is a health device or may further include information on the type of the health device, the manufacturer of the device, and/or the like. The gateway 104 recognizes that the health device 108 is connected with reference to the profile information included in the message.

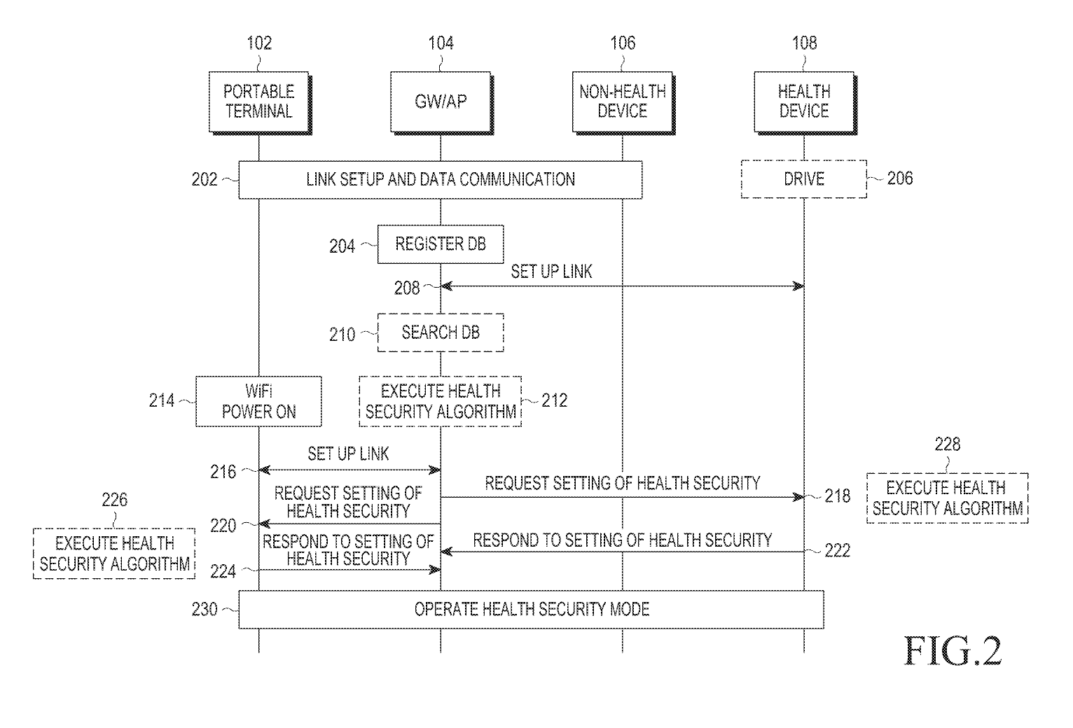

FIG. 2 is a message flowchart for explaining an execution procedure of a health security algorithm according to an embodiment of the present disclosure.

Referring to FIG. 2, at operation 202, the gateway 104 sets a communication link with the non-health device 106 and/or the portable terminal 102 through WiFi, and performs data communication.

At operation 204, a preliminary registration of the health device 108 (e.g., an operation of storing identification information on the health device 108 in the DB of the gateway 104) is performed. For example, at operation 204, the health device 108 registers with the gateway 104. Although it has been shown that operation 204 of performing a preliminary registration of the health device 108 is performed after operation 202, operation 204 may be performed at any time before communication is started by the health device 108 irrespective of the performance of operation 202. Further, operation 202 may be omitted.

At operation 206, the health device 108 is driven. For example, the health device 108 may be driven by switching on the power source.

After being driven by switching on a power source at operation 206, at operation 208, the health device 108 transmits a link setup message to the gateway 104. The health device 108 may receive a response message corresponding to the transmitted link setup message to set a communication link. According to various embodiments of the present disclosure, during or after a step of setting the communication link, a message further including at least one of profile information on the health device 108 and information on an additional security algorithm may be transmitted from the health device 108 to the gateway 104. According to various embodiments of the present disclosure, the health device 108 may specifically indicate a desired health security algorithm and/or security parameters.

When a DB storing preliminary registration information is present, at operation 210, the gateway 104 searches the DB for identification information on the health device 108. The identification information may be acquired at operation 208 of setting a link. If identification information on the health device 108 is present in the DB at operation 210, then, at operation 212, the gateway 104 executes a predetermined security algorithm for providing a higher level of security for a health care service (e.g., a health security algorithm). The health security algorithm may be executed on a communication link between the gateway 104 and the health device 108, and may be determined according to a selection of the manufacturer or the designer in advance.

At operation 218, the gateway 104 transmits a health security setting request message for requesting execution of a health security algorithm to the health device 108.

At operation 228, the health device 108 recognizes that a health security algorithm is executed by the health security setting request message in the gateway 104, and accordingly executes a health security algorithm.

At operation 222, the health device 108 transmits a health security setting response message that informs the gateway that the health security algorithm has been executed to the gateway 104.

Thereafter, at operation 230, communication of a health security mode protected by a health security algorithm is performed between at least the gateway 104 and the health device 108.

According to various embodiments of the present disclosure, when the user intends to connect to the health device 108 through the portable terminal 102 or identify the health data collected by the health device 108, a health security algorithm should also be performed even in the portable terminal 102. Accordingly, the gateway 104 instructs execution of a health security algorithm to the portable terminal 102 through the following procedure.

At operation 214, the portable terminal 102 executes a WiFi communication module. As an example, the portable terminal 102 may be initiated and/or powered on.

At operation 216, the portable terminal 102 sets a communication link by WiFi with the gateway 104. If the gateway 102 recognizes (e.g., determines) that a communication link is set with the portable terminal 102 after a health security algorithm is executed at operation 212, then the gateway 104 transmits a health security setting request message to the portable terminal at operation 220.

At operation 226, the portable terminal 102 executes a health security algorithm (e.g., in response to the health security setting request transmitted at operation 220). After executing a health security algorithm in response to the health security request message in operation 226, at operation 224, the portable terminal 102 responds with the health security setting response message.

Thereafter, at operation 230, communication protected by a health security algorithm is performed between at least the portable terminal 102, the gateway 104, and the health device 108. For example, at operation 230, the health device 108 may communicate with the gateway 104, may communicate with the portable terminal 102 through the gateway 104, or may directly communicate with the portable terminal 102.

When another health device is connected, the same operation may be repeatedly performed on the other health device.

However, because a health security algorithm of a higher level is continuously executed only for health devices, power consumption may be excessively generated in the gateway 104. Thus, when the health device releases a communication link, completing (e.g., terminating) execution of a health security algorithm may be necessary. According to various embodiments of the present disclosure, the gateway 104 may operate using the health security algorithm only when a health device is connected thereto. According to various embodiments of the present disclosure, the gateway 104 may operate using the health security algorithm only when a health device is connected thereto and sensitive information is transmitted between the gateway 104 and the health device connected thereto.

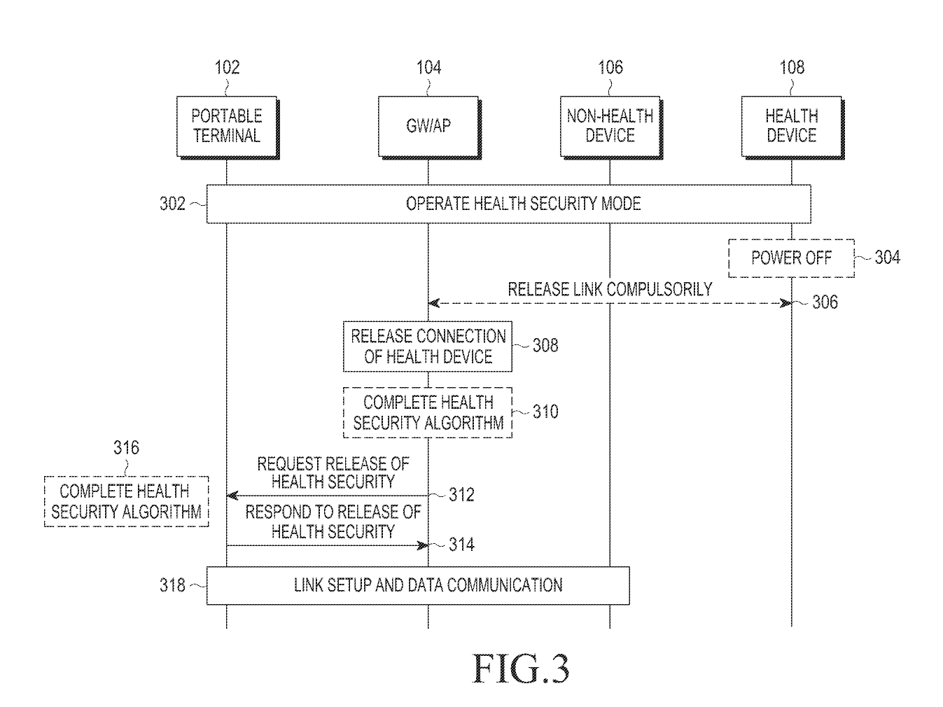

FIG. 3 is a message flowchart for explaining an ending procedure of a health security algorithm according to an embodiment of the present disclosure.

Referring to FIG. 3, at operation 302, the gateway 104, the health device 108, and the portable terminal 102 perform communication in a security mode protected by the health security algorithm.

At operation 304, the health device 108 is powered off For example, a power source of the health device 108 is switched off

If a power source of the health device 108 is switched off in operation 304, then, at operation 306, a communication link between the health device 108 and the gateway 104 is released. The communication link between the health device 108 and the gateway 104 may be compulsorily released (e.g., in response to the health device 108 being powered off). According to various embodiments of the present disclosure, the health device 108 may request a release of the communication link from the gateway 104 before the power source of the health device 108 is switched off

At operation 308, the gateway 104 detects that the communication with the health device 108 is released.

At operation 310, the health security algorithm which is being executed on the health device 108 is completed (e.g., terminated). According to various embodiments of the present disclosure, the gateway completes (e.g., terminates) a health security algorithm when all the connected health devices release the communication link.

If the portable terminal 102 executes a health security algorithm, then, at operation 312, the gateway 104 transmits a health security release request message for instructing a completion of (e.g., termination of) the health security algorithm to the portable terminal 102.

At operation 316, the portable terminal completes (e.g., terminates) the health security algorithm which is being executed on the health device 108 in response to the health security release request message.

At operation 318, the portable terminal 102 may transmit a response to the health security release request message transmitted at operation 316. If the portable terminal 102 transmits a health security release response message to the gateway 104 at operation 318, then an indication that the health security algorithm is completed (e.g., terminated) is provided. For example, the portable terminal 102 may be informed that the health security algorithm is completed (e.g., terminated).

Thereafter, at operation 318, communication to which a general algorithm of WiFi is applied is performed between the gateway 104, the non-health device 106, and the portable terminal 102.

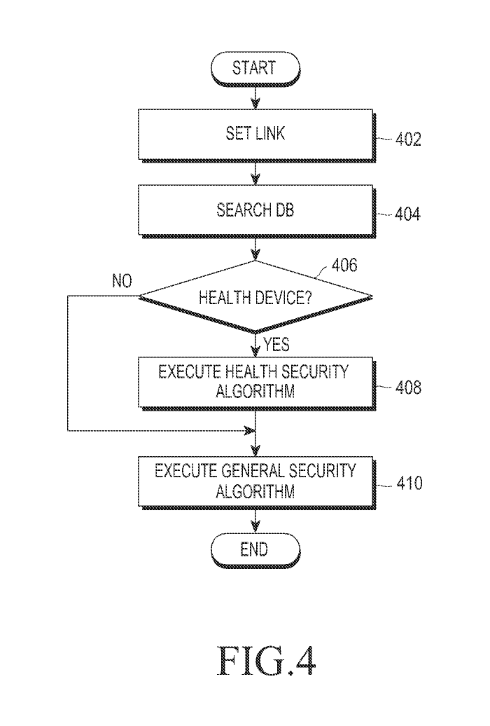

FIG. 4 is a flowchart showing an operation of executing a health security algorithm in a gateway according to an embodiment of the present disclosure.

Although various embodiments of the present disclosure in which a DB storing identification information of health devices is used has been described, a similar operation may be applied to a case in which a message including profile information is received from a health device. The shown operation may be performed irrespective of whether the non-health device is connected to the gateway.

Referring to FIG. 4, at operation 402, a communication link based on WiFi is set between the health devices and the communication device.

At operation 404, the gateway searches the DB for identification information of the registered health devices.

At operation 406, the gateway determines whether identification information on the communication device in which the communication link is set is stored in the DB.

If the gateway determines that the identification information is stored in the DB at operation 406, then the gateway may proceed to operation 408 at which the gateway determines that the communication device is a health device and executes a health security algorithm. The gateway may also request the health device to execute a health security algorithm. The gateway may also request a portable device connected thereto to execute the health security algorithm. According to various embodiments of the present disclosure, in response to determining that the communication device is health device (e.g., in response to determining that a health device is connected to the gateway), the gateway may request that all devices connected to the gateway or all devices that communicate health information with the gateway or nodes thereof use (e.g., execute) the health security algorithm. Thereafter, the gateway proceeds to operation 410.

Meanwhile, if the gateway determines that the identification information is not stored in the DB at operation 406, then the gateway may proceed to operation 410. For example, if the gateway determines that the identification information is not stored in the DB at operation 406, the gateway determines that the communication device is a non-health device. At operation 410, the gateway executes a general security algorithm of WiFi. Thereafter, the health security algorithm or the health security algorithm and the general security algorithm provide a security to the communication between the gateway and the communication device. As a selectable embodiment, the health security algorithm may replace a general security algorithm of WiFi to be used.

Although it will not be shown, the gateway may instruct execution of a health security algorithm to the portable terminal according to selection of the user or a preliminary setting after the health security algorithm is executed in operation 408. Accordingly, a health security algorithm is applied to communication between the portable terminal, and the gateway and the health device.

FIG. 5 is a flowchart showing an operation of ending a health security algorithm in a gateway according to an embodiment of the present disclosure.

Referring to FIG. 5, at operation 502, a release of a communication link set with the communication device based on WiFi is detected.

At operation 504, a determination is made as to whether the communication device is a health device. According to various embodiments of the present disclosure, the determination may be performed with reference to a search of the DB, profile information included in the message received from the health device, and a context stored with respect to a communication link.

If the communication device is determined not to be a health device at operation 504, then the operation of ending the health security algorithm may end.

If the communication device is determined to be a health device at operation 504, then, at operation 506, the gateway completes (e.g., terminates) a health security algorithm performed on the communication link or commonly applied to the communication with the health devices.

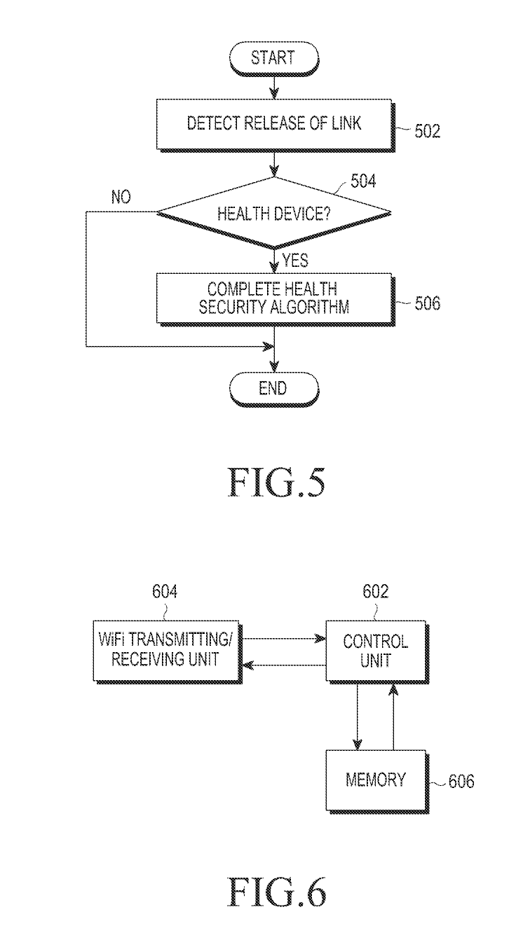

FIG. 6 is a block diagram showing a configuration of a gateway for executing a health security algorithm according to an embodiment of the present disclosure.

Referring to FIG. 6, the gateway may include a control unit 602, a WiFi transmitting/receiving unit (e.g., a communication unit) 602, and a memory 606. The gateway performs communication according to a predetermined communication protocol such as WiFi, Bluetooth, ZigBee, and/or the like with the portable terminal, the health devices, and the non-health devices through a transceiver 604.

If the gateway detects (e.g., determines) that a communication link with a communication device is set by the transceiver 604, the controller 602 determines whether the communication device is a health device. For example, the controller 602 may determine whether the communication device is a health device with reference to identification information of the health devices registered in the memory 606 in advance or profile information in the message received from the communication device through the transceiver 604.

If the communication device is identified as (e.g., determined to be) a health device, then the same health security algorithm is executed in the health device by executing a health security algorithm designated in advance and informing the health device of the execution of the health security algorithm through the transceiver 604. According to various embodiments of the present disclosure, if the gateway (e.g., the controller 602) determines that the communication device connected to the gateway through the gateway is a health device, then the communication between the gateway and the communication device may use a health security algorithm (e.g., the gateway and/or the health device may execute the health security algorithm). If the communication link with the health device is released, then the controller 602 completes (e.g., terminates) the health security algorithm to reduce power consumption.

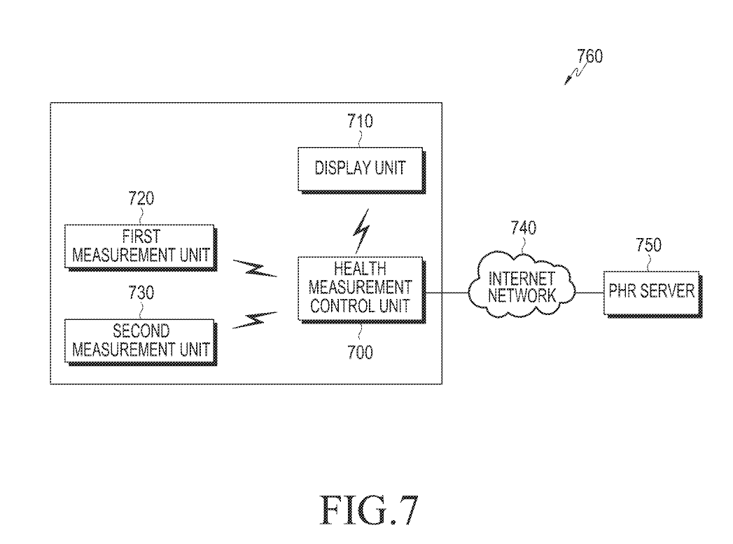

FIG. 7 is a view showing a Personal Health Record (PHR) management system according to an embodiment of the present disclosure.

Referring to FIG. 7, according to various embodiments of the present disclosure, the PHR management system 760 includes a health measurement control unit 700, a display unit 710, a first measurement unit 720, a second measurement unit 730, and a PHR server 750. According to various embodiments of the present disclosure, the PHR management system 760 may include a network such as, for example, an internet network 740.

According to various embodiments of the present disclosure, the health measurement control unit 700, the display unit 710, the first measurement unit 720, and the second measurement unit 730 may be provided at home, and the PHR server 750 may be provided in a hospital.

The display unit 710 may be, for example, a portable terminal, a mobile phone, a Personal Digital Assistants (PDA), and a personal computer, and the first measurement unit 720 and the second measurement unit 730 may be devices for measuring personal health. For example, the first measurement unit 720 and the second measurement unit 730 may be health devices such as a scale, a glucometer, a blood pressure monitor, a heart rate monitor, and/or the like. According to various embodiments of the present disclosure, the health measurement control unit 700 may be located at home, and may be a gateway for registering and managing the health devices. Although FIG. 7 shows only two measurement units 720 and 730, an additional measurement unit may be included (e.g., any number of additional measurement units may be included). The first measurement unit 720 and the second measurement unit 730 include a security function, and a security algorithm may be executed according to setting of a security and the security algorithm may be different for the measurement units.

The health measurement control unit 700 controls execution of securities of the first measurement unit 720 and the second measurement unit 730 according to an instruction of the PHR server 750 or the display unit 710. If the measurement units transmit measurement data while a security is executed on the measurement data, then the measurement data may be provided to the display unit 710 after the security of the measurement data is released. Execution of security may correspond to execution of encryption and/or the like, and releasing of the security may correspond to generating plain data by releasing encryptions (e.g., decryption).

The PHR server 750 stores a PHR collected through the measurement units and may determine execution of the security of the measurement units, and accordingly, the measurement units may be registered in the PHR server 750 and the PHR server 750 may store information on the security algorithms of the measurement units.

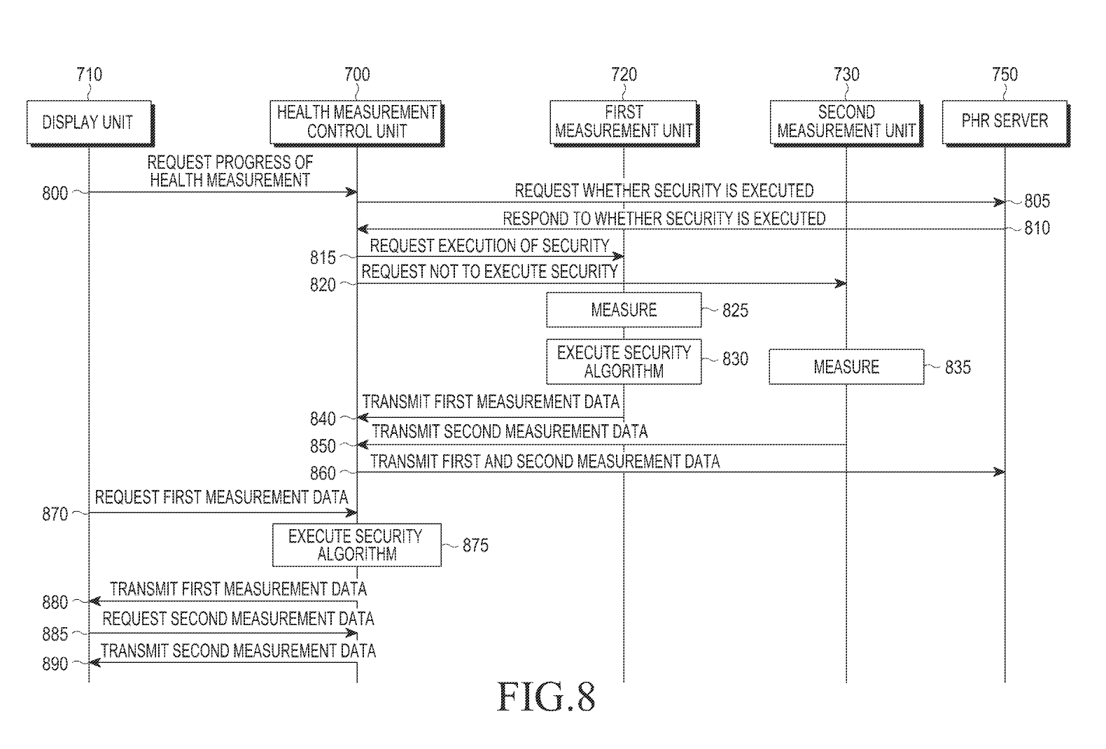

FIG. 8 is a flowchart for explaining an operation of a PHR management system according to an embodiment of the present disclosure.

Referring to FIG. 8, at operation 800, a user transmits a health measurement progress request related to the first measurement unit 720 and/or the second measurement unit 730 to the health measurement control unit 700 through the display unit 710.

In response to the health measurement progress request, at operation 805, the health measurement control unit 700 requests information on execution of a security of the first measurement unit 720 and/or the second measurement 730 from the PHR server 750.

At operation 810, the PHR server 750 determines execution of securities of the measurement units according to the situation and transmits the determined information to the health measurement control unit 700 while the information is carried in the response to the execution of a security. For example, when health data measured by the first measurement unit 720 are important data as compared with the second measurement unit 730, the PHR server 750 may determine that the first measurement unit 720 executes a security and that the second measurement unit 730 does not execute a security. Then, the PHR server 750 may determine execution of securities of the measurement units in consideration of the health state of the user, the type of the measurement units, purposes of health measurements, and/or the like.

The PHR server 750 may transmit security related information on the measurement unit which has been determined to execute a security when execution of a security is responded to the health measurement control unit 700. The security related information may include, for example, the type of a security algorithm which will be applied to the security of data and/or an input parameter thereof This is because a security of measured data can be released such that the user recognizes the data from the display unit 710 when data measured by the health measurement control unit 700 is provided to the display unit 710, and when security related information on the measurement units is stored in the health measurement control unit 700 in advance, transmission of separate security related information may be omitted.

If the health measurement control unit 700 receives a response on execution of a security, then at operations 815 and 820, the health measurement control unit 700 transmits a message controlling execution of securities of the measurement units to the measurement units. For example, at operation 815, the first measurement unit 720 is requested to execute a security (e.g., a security algorithm, encryption, and/or the like), and at operation 820, the second measurement unit 730 is requested not to execute a security (e.g., a security algorithm, encryption, and/or the like).

At operation 825, the first measurement unit 720 measures health of the user. For example, the first measurement unit 720 may measure one or more characteristics relating to a user's health.

If the first measurement unit 720 measures data on the health of the user at operation 825, then, at operation 830, the first measurement unit 720 executes a security algorithm on the data. Thereafter, at operation 840, the first measurement unit 720 transmits the first measurement data to the health measurement control unit 700.

At operation 835, the second measurement unit 730 measures data on the health of the user. At operation 850, the second measurement unit 730 transmits the second measurement data to the health measurement control unit 700. Because the second measurement unit 730 does not execute a security, the second measurement unit 730 measures data on the health of the user at operation 835, and transmits second measurement data to the health measurement control unit 700 without executing a security algorithm on the measured data at operation 850.

If the health measurement control unit 700 receives the first measurement data and/or the second measurement data, the health measurement control unit 700 may transmit the first measurement data and/or the second measurement data to the PHR server 750. For example, in response to receiving the first measurement data and the second measurement data, at operation 860, the health measurement control unit 700 transmits the data to the PHR server 750. The health measurement control unit 700 transmits the corresponding data to the user if the user makes a request.

Thereafter, at operation 870, the user may request the first measurement data. For example, the display unit 710 may transmit a request for the first measurement data to the health measurement control unit 700. If the user requests first measurement data at operation 870, then, at operation 875, the health measurement control unit 700 may execute a security algorithm (e.g., in relation to the first measurement data). Thereafter, at operation 880, the health measurement control unit 700 may transmit the first measurement data to the display unit 710. A security algorithm is executed on the first measurement data to release a security because a security is executed on the first measurement data such that the data whose security is released is transmitted to the display unit 710.

At operation 885, the user may request the second measurement data. For example, the display unit 710 may transmit a request for the second measurement data to the health measurement control unit 700. In response to the user requesting the second measurement data at operation 885, at operation 890, the health measurement control unit 700 may transmit the second measurement data to the display unit 710 while a security algorithm is not executed because a security is not executed on the second measurement data.

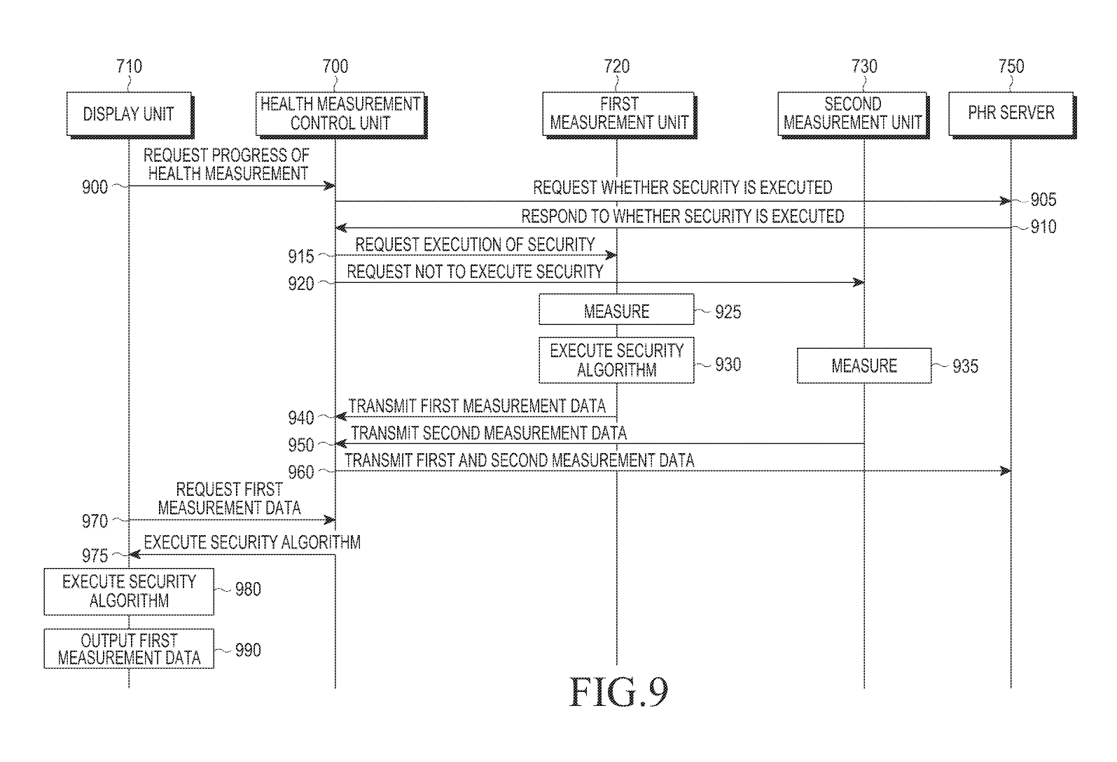

FIG. 9 is a flowchart for explaining an operation of a PHR management system according to another embodiment of the present disclosure.

Referring to FIG. 9, at operation 900, a user may transmit a request of a health measurement progress. For example, the display unit 710 may transmit a request for the health measurement progress to the health measurement control unit 700.

If the user transmits a health measurement progress request related to the first measurement unit 720 and the second measurement unit 730 to the health measurement control unit 700 through the display unit 710 at operation 900, then, at operation 905, the health measurement control unit 700 requests information on execution of a security of the first measurement unit 720 and the second measurement unit 730 from the PHR server 750.

At operation 910, the PHR server 750 may transmit a response to whether security is executed to the health measurement control unit 700. For example, the PHR server 750 transmits a security execution response including information on execution of a security in which a security is executed on the first measurement unit 720 and a security is not executed on the second measurement unit 730 to the health measurement control unit 700. Then, the PHR server 750 may transmit security related information on the first measurement unit 720 to the health measurement control unit 700. The security related information may include, for example, information on a security algorithm executed by the first measurement unit 720.

In response to receiving a security execution response, the health measurement control unit 700 may communicate with the corresponding measurement units to request execution of an applicable security setting (e.g., request to execute a security, request not to execute a security, and/or the like). For example, if the health measurement control unit 700 receives a security execution response, then, at operation 915, the health measurement control unit 700 requests the first measurement unit 720 to execute a security, and at operation 920, the health measurement control unit 700 requests the second measurement unit 730 not to execute a security.

At operation 925, the first measurement unit 720 measures a characteristic (e.g., a data) on the health of the user. If data on the health of the user is measured at operation 925, then at operation 930, the first measurement unit 720 executes a security algorithm on the data. Thereafter, at operation 940, the first measurement unit 720 transmits the first measurement data to the health measurement control unit 700.

At operation 935, the second measurement unit 730 measures a characteristic (e.g., a data) on the health of the user. If data on the health of the user is measured at operation 935, then, at operation 950, the second measurement unit 730 transmits the second measurement data to the health measurement control unit 700. Because the second measurement unit 730 does not execute a security, if the second measurement unit 730 measures data on the health of the user at operation 935, the second measurement unit 730 transmits second measurement data to the health measurement control unit 700 without executing a security algorithm on the measured data.

If the health measurement control unit 700 receives the first measurement data and/or the second measurement data, the health measurement control unit 700 may transmit the first measurement data and/or the second measurement data to the PHR server 750. For example, in response to receiving the first measurement data and the second measurement data, at operation 960, then the health measurement control unit 700 transmits the data to the PHR server 750. The health measurement control unit 700 transmits the corresponding data to the user if the user makes a request.

Thereafter, at operation 970, the user may request the first measurement data. For example, the display unit 710 may transmit a request for the first measurement data to the health measurement control unit 700. Then, if the user requests first measurement data at operation 970, then, at operation 975, security algorithm related information as well as the first measurement data may be transmitted to the display unit 710 to release a security because a security is executed on the first measurement data. Then, when a security algorithm for the measurement units is stored in the display unit 710, transmission of the security algorithm related information may be omitted. If the display unit 710 receives the first measurement data, then, at operation 980, the display unit 710 releases a security by executing a security algorithm on the first measurement data, and at operation 990, the display unit 710 outputs the data whose security is released.

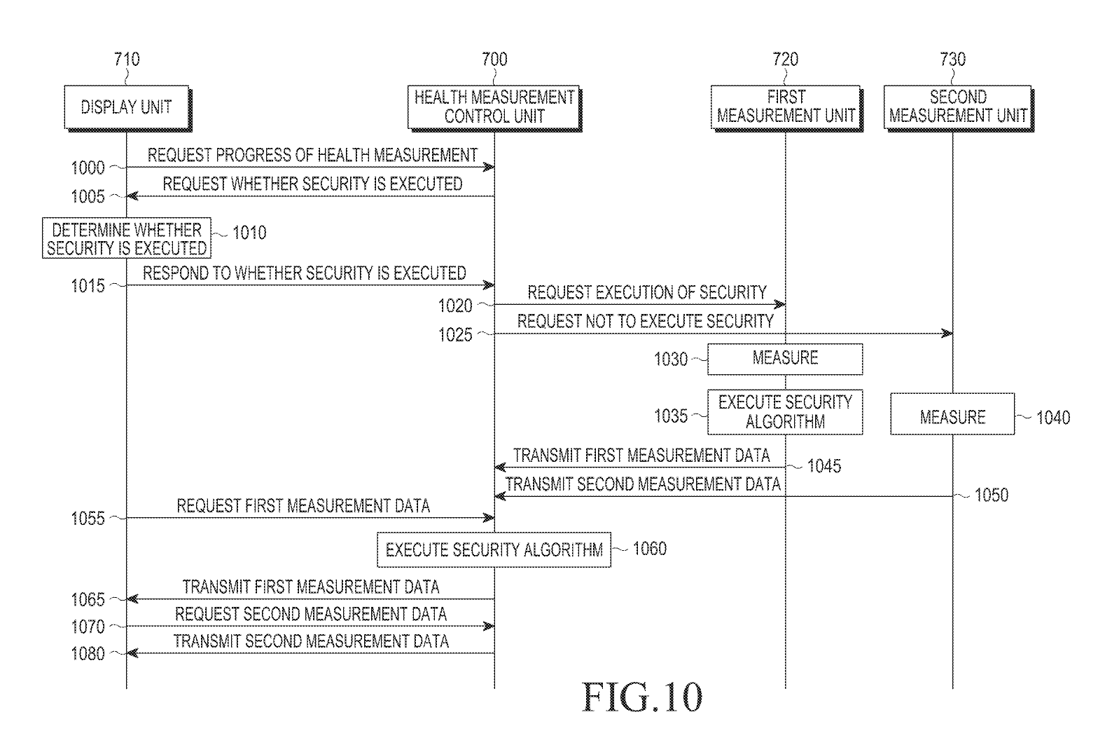

FIG. 10 is a flowchart for explaining an operation of a PHR management system according to another embodiment of the present disclosure.

In the embodiment of FIG. 10, the display unit 710 may determine execution of a security on the measurement units.

Referring to FIG. 10, at operation 1000, a user may transmit a request of a health measurement progress. For example, the display unit 710 may transmit a request for the health measurement progress to the health measurement control unit 700.

If the user transmits a health measurement progress request related to the first measurement unit 720 and the second measurement unit 730 to the health measurement control unit 700 through the display unit 710 at operation 1000, then, at operation 1005, the health measurement control unit 700 requests information on execution of a security of the first measurement unit 720 and the second measurement unit 730 from the display unit 710.

At operation 1010, the display unit 710 determines whether a security is executed on a corresponding measurement unit. For example, the display unit determines such that a security is executed on the first measurement unit 720 and a security is not executed on the second measurement unit 730. At operation 1015, the display unit 710 transmits the determined information to the health measurement unit 700 while a security execution response is carried in the determined information. Then, the display unit 710 may transmit security related information on the first measurement unit 720 to the health measurement control unit 700, and the security related information may include information on the security algorithm executed by the first measurement unit 720. When requesting a health measurement progress from the health measurement unit 700, the display unit 710 may transmit information on execution of a security on the measurement units and security related information.

The health measurement control unit 700 may transmit to corresponding measurement units requests that indicate whether the particular measurement unit is to execute a security. For example, at operation 1020, the health measurement control unit 700 may transmit a request for execution to the first measurement unit 700, and at operation 1025, the health measurement control unit 720 may transmit a request not to execute a security to the second measurement unit 730. If the health measurement control unit 700 receives a security execution response, at operation 1020, the health measurement control unit 700 requests the first measurement unit 720 to execute a security, and at operation 1025, the second measurement unit 730 not to execute a security in operation 1025.

At operation 1030, the first measurement unit 720 measures a characteristic (e.g., a data) on the health of the user. If data on the health of the user is measured at operation 1030, then, at operation 1035, the first measurement unit 720 executes a security algorithm on the measurement data. Thereafter, at operation 1045, the first measurement unit 720 transmits the first measurement data to the health measurement control unit 700.

At operation 1040, the second measurement unit 730 measures a characteristic (e.g., a data) on the health of the user. If data on the health of the user is measured at operation 1040, then, at operation 1050, the second measurement unit 730 transmits the second measurement data to the health measurement control unit 700. Because the second measurement unit 730 does not execute a security, the second measurement unit 730 measures data on the health of the user at operation 1040, and the second measurement unit 730 transmits the generated second measurement data to the health measurement control unit 700 without executing a security algorithm on the measured data.

Thereafter, at operation 1055, the user may request the first measurement data. For example, the display unit 710 may transmit a request for the first measurement data to the health measurement control unit 700. If the user requests first measurement data at operation 1055, then releasing a security to allow the user to read the first measurement data may be necessary. When security related information is stored in the display unit 710, the health measurement control unit 700 may transmit the first measurement data to the display unit 710 without performing a separate security releasing step. At operation 1060, the health measurement control unit 700 may execute a security algorithm on the first measurement data to release a security. Thereafter, at operation 1065, the health measurement control unit 700 may transmit data whose security is released to the display unit 710.

At operation 1070, the user may request the second measurement data. For example, the display unit 710 may transmit a request for the second measurement data to the health measurement control unit 700. In response to the user requesting the second measurement data at operation 1070, at operation 1080, the health measurement control unit 700 transmits the second measurement data to the display unit 710 while a security algorithm is not executed because a security is not executed on the second measurement data.

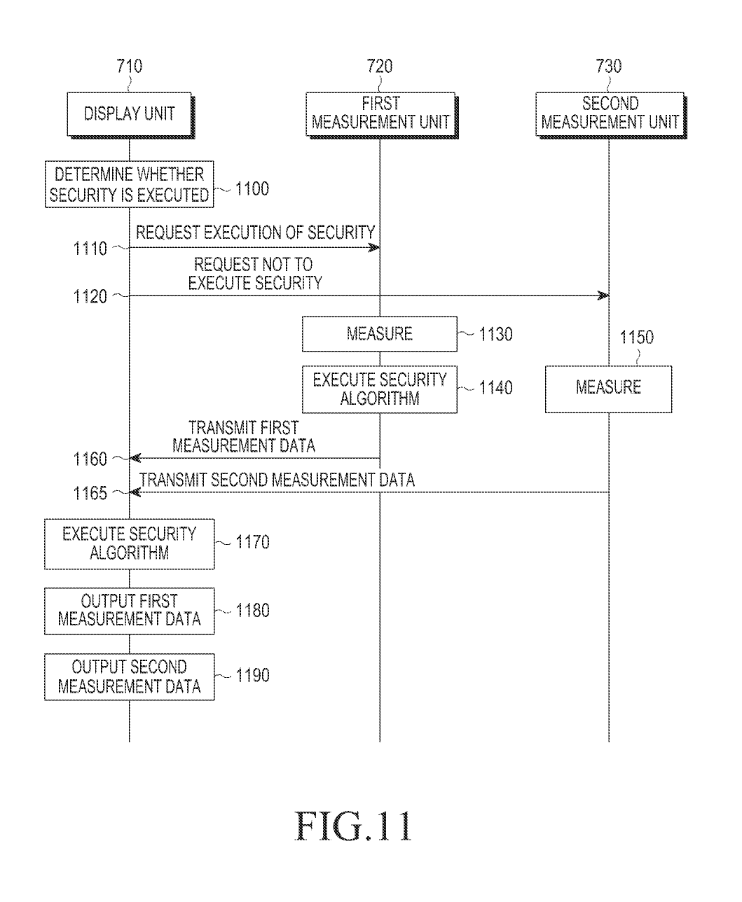

FIG. 11 is a flowchart for explaining an operation of a PHR management system according to an embodiment of the present disclosure.

Referring to FIG. 11, the display unit 710 may control execution of a security of the first measurement unit 720 and the second measurement unit 730. At operation 1100, the display unit 710 may determine whether security is executed. For example, if the user determines that a security is executed on the first measurement unit 720 and that a security is not executed on the second measurement unit 730 through the display unit at operation 1100, then at operation 1110, the display unit 710 requests the first measurement unit 720 to execute a security, and at operation 1120, the display unit 710 requests the second measurement unit 730 not to execute a security.

At operation 1130, the first measurement unit 720 measures a characteristic (e.g., a data) on the health of the user. If data on the health of the user is measured at operation 1130, then, at operation 1140, the first measurement unit 720 executes a security algorithm on the measurement data. Thereafter, at operation 1160, the first measurement unit 720 transmits the generated first measurement data to the display unit 710.

At operation 1150, the second measurement unit 730 measures a characteristic (e.g., a data) on the health of the user. If data on the health of the user is measured at operation 1150, then, at operation 1165, the second measurement unit 730 transmits the second measurement data to the display unit 710. Because the second measurement unit 730 does not execute a security, at operation 1150, the second measurement unit 730 measures data on the health of the user, and at operation 1165, the second measurement unit 730 transmits the generated second measurement data to the display unit 710 without executing a security algorithm on the measured data.

At operation 1170, the display unit 710 executes a security algorithm (e.g., to release the security protection of the first measurement data, and thereafter, at operation 1180, the display unit 710 outputs the first measurement data with the released security. For example, in response to the user requesting display of the measurement data, the display unit 710 releases the security by executing a security algorithm on the first measurement data because a security is executed on the first measurement data at operation 1170 and outputs the measurement data whose security is released at operation 1180. At operation 1190, the second measurement data is directly output while the security algorithm is not executed because a security is not executed on the second measurement data.

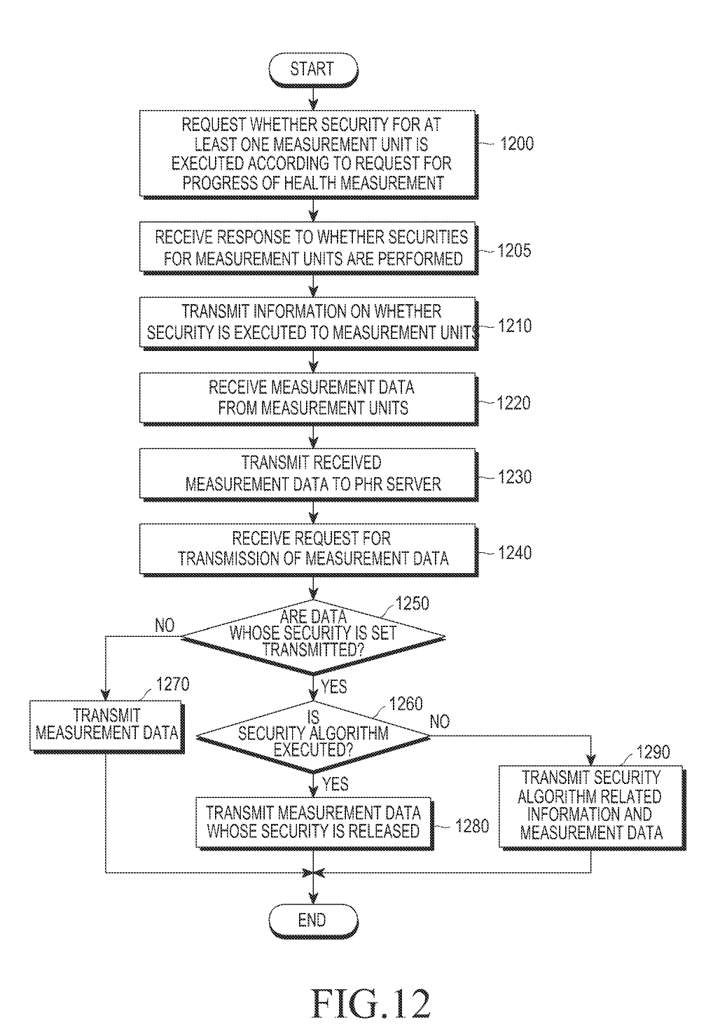

FIG. 12 is a flowchart showing an operation of a health measurement control apparatus of a PHR management system according to an embodiment of the present disclosure.

Referring to FIG. 12, at operation 1200, information on execution of a security on at least one measurement unit is requested from the user or the PHR server 750 according to a health measurement progress request of the user.

At operation 1205, a response on execution of a security of the measurement units is received. Then, the measurement unit executing a security may receive security related information including information on the security algorithm executed by the measurement unit together.

At operation 1210, information on whether security is executed is transmitted to the corresponding measurement units. At operation 1220, the corresponding measurement units receive the measurement data. If information on execution of a security is transmitted to the measurement units at operation 1210 and data on the health of the user measured by the measurement units are received at operation 1220, then at operation 1230, the received measurement data are transmitted to the PHR server 750.

At operation 1240, a request for transmission of measurement data is received. At operation 1250, a determination is made as to whether the data having security set is transmitted. In response to the user request for transmission of measurement data at operation 1240, and if the requested data is determined to correspond to data whose security is set at operation 1250, then, at operation 1260, a determination is made as to whether the security algorithm is executed. If a security algorithm is determined to be executed at operation 1260, then at operation 1280, the measurement data whose security is released are transmitted to the user. In contrast, if the security algorithm is determined not to be executed at operation 1260, then at operation 1290, measurement data and security algorithm related information are provided to the user. If the requested data is determined to correspond to data whose security is not set at operation 1250, then at operation 1270, the measured data is transmitted without performing a security releasing.

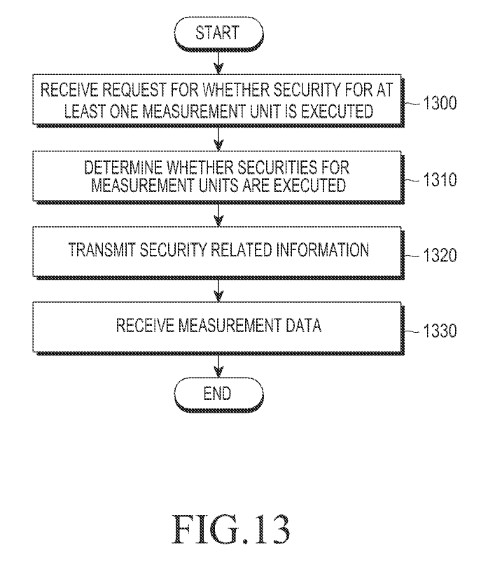

FIG. 13 is a flowchart showing an operation of a PHR server of a PHR management system according to an embodiment of the present disclosure.

Referring to FIG. 13, at operation 1300, a request for information on execution of a security on at least one measurement unit is received from the health measurement control unit 700. At operation 1310, a determination as to whether a security on the measurement units is executed. At operation 1320, security related information is transmitted to the health measurement control unit 700. Then, the measurement unit executing a security may transmit security related information including information on the security algorithm executed by the measurement unit together. Thereafter, at operation 1330, health related data of the user measured by the health measurement control unit 700 is received.

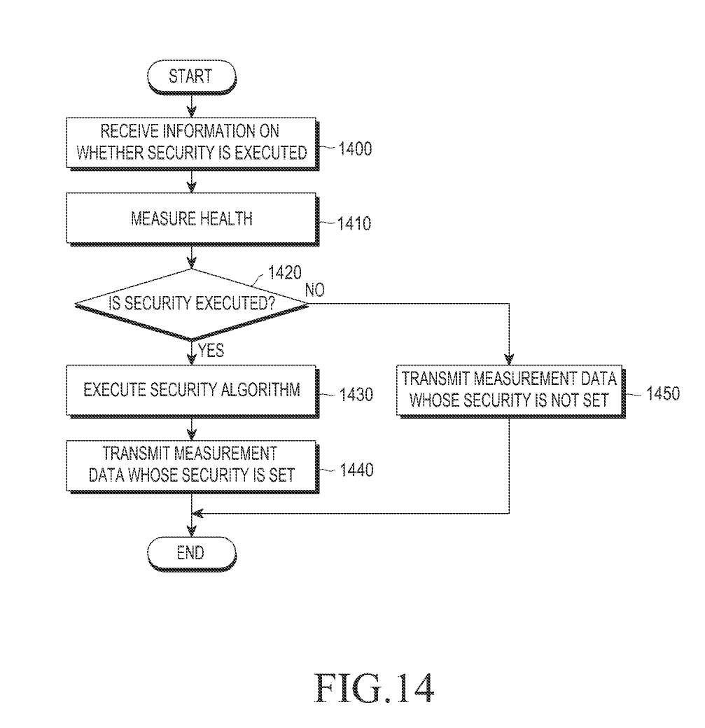

FIG. 14 is a flowchart showing an operation of a measurement apparatus of a PHR management system according to an embodiment of the present disclosure. Although FIG. 14 exemplifies the first measurement unit 720, and various embodiments of the present disclosure may be applied to other measurement units including the second measurement unit 730 in the same way.

At operation 1400, information on whether security is executed is received. If information on execution of a security is received from the health measurement control unit 700 or the user, then at operation 1410, data on the health of the user are measured. At operation 1420, a determination is made as to whether the security is executed. As a result, a security of the measured data is set according to execution of a security. For example, if a security is determined to be executed at operation 1420, then at operation 1430, a security algorithm is executed, and at operation 1440, the measurement data whose security is set is transmitted to the health measurement control unit 700 or the user. In contrast, if a security is determined not to be executed at operation 1420, then at operation 1450, measurement data whose security is not set is transmitted.

According to the disclosed embodiment of the present disclosure, a requirement for a security of a health system can be satisfied by discriminatively providing a security algorithm of a higher level as compared with non-health devices using the same communication protocol to health devices dealing with secret information of the user. Further, a waste of power consumption in a gateway can be prevented by reducing power consumption due to driving of a security algorithm of a high level as much as possible.

In addition, according to various embodiments of the present disclosure, because the PHR server determines execution of a security of the measurement unit and manages security algorithms of the measurement units, the securities of the measurement units can be improved, and because execution of securities of the measurement units is determined according to situations, a resource can be efficiently used without performing a security whenever all the measurement units perform measurements.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. A method of providing a security by a gateway in a health system, the method comprising:
setting a communication link according to a first communication protocol with a communication device;
determining whether the communication device is a health device;
if the communication device is a health device, performing a health security algorithm providing a security of a level higher than a security of a security algorithm applied in the first communication protocol; and
performing a communication with the health device by using the health security algorithm.

2. The method of claim 1, wherein the determining of whether the communication device is a health device comprises:
searching for identification information on the communication device from a Data Base (DB) in which information of health devices are registered in advance; and
if the identification information is present in the DB, determining that the communication device is the health device.

3. The method of claim 1, wherein the determining of whether the communication device is a health device comprises:
extracting a profile on the communication device from a message received from the communication device; and
determining whether the communication device is the health device based on the profile information.

4. The method of claim 1, wherein the first communication protocol is at least one of WiFi, Bluetooth, and ZigBee.

5. A gateway apparatus for providing a security for a health system, the gateway apparatus comprising:
a transceiver configured to perform a communication with at least one communication device; and
a controller configured to, if a communication link according to a first communication protocol with the communication device is set, determine whether the communication device is a health device, if the communication device is a health device, perform a health security algorithm providing a security of a level higher than a security of a security algorithm applied in the first communication protocol, and perform a communication with the health device by using the health security algorithm.

6. The gateway apparatus of claim 5, wherein the controller searches for identification information on the communication device from a Data Base (DB) in which information of health devices are registered in advance, and if the identification information is present in the DB, determines that the communication device is the health device.

7. The gateway apparatus of claim 5, wherein the controller extracts a profile information on the communication device from a message received from the communication device, and determines whether the communication device is the health device based on the profile information.

8. The gateway apparatus of claim 5, wherein the first communication protocol is at least one of WiFi, Bluetooth, and ZigBee.

9. A method of managing a health record, the method comprising:
receiving first control information on whether security of at least one measurement apparatus is executed from a health record management server or a user;
transmitting second control information on whether security of the at least one measurement apparatus is executed to the at least one measurement apparatus based on the first control information;
receiving data measured by the at least one measurement apparatus and generated based on the second control information; and
providing the data to one or more of the health record management server and the user.

10. The method of claim 9, wherein the first control information comprises information on a security algorithm executed by the at least one measurement apparatus.

11. The method of claim 9, wherein the providing of the data comprises
when a security is set in the data received from the measurement apparatus, releasing the security set in the received data and providing the data from which the security is released to the user.

12. The method of claim 9, wherein the providing of the data comprises:
when a security is set in the data received from the measurement apparatus, providing information on a security algorithm executed by the at least one measurement apparatus to the user.

13. A method of managing a health record, the method comprising:
determining whether a security of at least one measurement apparatus is executed; and
generating control information on whether a security of the at least one measurement apparatus is executed;
transmitting the control information to the at least one measurement apparatus; and
receiving data measured by the at least one measurement apparatus and generated based on the control information.

14. The method of claim 13, wherein the control information comprises information on a security algorithm executed by the at least one measurement apparatus.

15. The method of claim 13, wherein the transmitting of the control information comprises:
transmitting the control information to a health measurement control apparatus for controlling the measurement apparatus.

16. The method of claim 13, further comprising, when the received data are data in which a security is set,
releasing the security of the received data; and
outputting data from which the security is released.

17. A method of managing a health record, the method comprising:
determining whether a security is executed on health data based on control information provided by one or more of a health record management server and a user;
measuring the health data;
executing a security algorithm to set a security in the measured health data according to the determination; and
transmitting the data in which the security is set to one or more of the health record management server and the user.

18. An apparatus for managing a health record, the apparatus comprising:
a transmitter configured to transmit a signal;
a receiver configured to receive a signal; and
a controller configured to transmit second control information on whether security of the at least one measurement apparatus is executed to the at least one measurement apparatus based on the first control information on whether security of at least one measurement apparatus is executed from a health record management server or a user, and to receive data measured by the at least one measurement apparatus and generated based on the second control information and transmits the data to the health record management server or the user.

19. The apparatus of claim 18, wherein the first control information comprises information on a security algorithm executed by the at least one measurement apparatus.

20. The apparatus of claim 18, wherein, when a security is set in the data received from the measurement apparatus, the controller releases the security set in the received data and provides the data from which the security is released to the user.

21. The apparatus of claim 18, wherein, when a security is set in the data received from the measurement apparatus, the controller provides information on a security algorithm executed by the at least one measurement apparatus to the user.

22. An apparatus for managing a health record, the apparatus comprising:
a transmitter configured to transmit a signal;
a receiver configured to receive a signal;
a controller configured to determine whether a security is executed on at least one measurement apparatus, to generate control information on whether a security is executed, and to transmit the control information to the at least one measurement apparatus.

23. The apparatus of claim 22, wherein the control information comprises information on a security algorithm executed by the at least one measurement apparatus.

24. The apparatus of claim 22, wherein the controller transmits the control information to a health measurement control apparatus for controlling the measurement apparatus.

25. The apparatus of claim 22, wherein, when the received data are data in which a security is set, the controller releases the security of the received data and outputs the data from which the security is released.

26. An apparatus for managing a health record, the apparatus comprising:
a transmitter configured to transmit a signal;
a receiver configured to receive a signal;
a controller configured to determine whether a security is executed on health data based on control information provided by a health record management server or a user, and to execute a security algorithm to set a security in the measured health data according to whether a security is executed.

27. A non-transitory computer-readable storage medium storing instructions that, when executed, cause at least one processor to perform the method of claim 1.

28. A non-transitory computer-readable storage medium storing instructions that, when executed, cause at least one processor to perform the method of claim 9.

29. A non-transitory computer-readable storage medium storing instructions that, when executed, cause at least one processor to perform the method of claim 13.

30. A non-transitory computer-readable storage medium storing instructions that, when executed, cause at least one processor to perform the method of claim 17.

31. The method of claim 1, wherein if the communication device is determined to be a health device, then setting a security level of all communication links between the gateway and devices connected to the gateway to be a higher level of security than a level of security of communication when a health device is not connected to the gateway.
